(19) United States
(12) Patent Application Publication
(10) Pub. No.: US 2013/0137567 A1
(43) Pub. Date: May 30, 2013

(54) DEVICE TO CLEAN SILOXANES FROM BIOGAS, AND A METHOD OF REGENERATING THE SAME INCLUDING ELECTRIC SWING ADSORPTION

(71) Applicant: John Chrysostom Stasko, Everett, WA (US)

(72) Inventor: John Chrysostom Stasko, Everett, WA (US)

(73) Assignee: Applied Filter Technology, Inc.

(21) Appl. No.: 13/482,420

(22) Filed: May 29, 2012

Related U.S. Application Data
(60) Provisional application No. 61/491,104, filed on May 27, 2011.

(51) Int. Cl. B01J 20/34

(52) U.S. Cl. CPC B01J 20/3441
USPC 502/5; 34/246

(57) ABSTRACT

A siloxane-adsorbent media regeneration device, system and method comprising a rectangular cylinder with first and second dielectric elements forming opposing first and second sides, and first and second electrodes forming opposing third and fourth sides thereof, and end caps disposed at opposing ends thereof. A capacitive device is coupled with the dielectric elements and configured to detect a capacitance of an adsorbent media, and a switchable heat source coupled with each of the first and second dielectric elements. A pressure vessel is configured to receive the rectangular cylinder therein, and includes apertures to permit inflow and outflow of a gas. A vibration-generating device may be coupled with one of the electrodes, as well as with a control system. Regeneration generally includes passing an electrical current through an adsorbent medium, detecting a capacitance indicating that regeneration is warranted, and heating the adsorbent medium while conveying an inert gas therethrough.

### RELATED APPLICATIONS

This application claims the benefit of priority to U.S. Provisional Application number 61/491,104, filed on May 27, 2011 and entitled A DEVICE TO CLEAN SILOXANES FROM BIOGAS, WHICH IS REGENERABLE BY WAY OF ELECTRIC SWING ADSORPTION, the contents of which are hereby incorporated herein in their entirety by this reference.

### FIELD OF THE INVENTION

The invention relates generally to the field of biogas processing, and more particularly, to the reuse of media used to remove siloxanes from biogas.

### BACKGROUND OF THE INVENTION

To position Applied Filter Technology as the leader of biogas cleaning technology, a careful review of current technologies has been made regarding siloxane remediation. Adsorbent media is clearly the best solution since other developed technologies, such as membranes and acid-base catalysis have higher total costs. There are many types of adsorbent media, however, and regeneration can be effected by various techniques.

The available adsorbent media ranges from activated carbon to zeolites to polyamide resins. Polyamide resins are expensive and have poor temperature stability (below 160C.), although they are currently successfully used for this purpose by PpTek, (J. Hayward; Fuel cleaning for gas fired engines, U.K. Patent 2,440,123, Jul. 19, 2006). Not only do zeolites have a higher price per adsorptive capacity (Finocchio et al., Purification of biogases from siloxanes by adsorption: On the regenerability of activated carbon sorbents; Energy & Fuels, 23(8):4156-4159, 2009.), they are destroyed by siloxanes, reducing their life (Parker et al., Unexpected destructive dealumination of zeolite beta by silylation; Journal of Physical Chemistry C, 114(8):8459-8, May 13, 2010).

Activated carbon also experiences a loss in its ability to adsorb siloxanes (Finocchio et al., supra.), however, due to its attractive cost and since it has been successfully regenerated, (Mark Rawson; Removal of siloxane and H2S from biogas using microwave energy; Draft final report, Sacramento Municipal Utility District, 6201 S Street, Sacramento, Calif. 95817, 2011. Public Interest Energy Research Program, (PIER)) it appears to be the most likely candidate for a regenerable system.

Considering the technique for regeneration, generally the process is performed using a temperature-swing adsorption (TSA) technique. Indeed, simply using pressure-swing adsorption or pressure-vacuum-swing adsorption does not yield a significant enough amount of media regeneration for a variety of reasons. However, temperature-swing adsorption can be implemented in a variety of ways, such as heating the media using hot gas which is what PpTek (refer to Hayward, supra) or Domnick Hunter (a division of Parker Hannifin Corp., Gateshead, U.K.) uses, or heating the media using microwaves (C.Y. Cha; Process for microwave air purification, U.S. Pat. No. 6,207,023, Mar. 27, 2001). Other permutations of these ideas exist (Paul Tower et al.; Regenerable purification system for removal of siloxanes and volatile organic carbons, U.S. Pat. No. 7,410,524, Aug. 12, 2008).

Both of these techniques are fraught with problems. PpTek and Domnick Hunter need large volumes of gas at a very low specific heat, such as air or exhaust gas, to heat a refractory substance which has a high specific heat The very large volume of gas required necessitates equipment which can process the resulting large, dilute volume of gas. On the other hand, microwaves have poor penetration so the device described in U.S. Pat. No. 6,207,023 goes through great lengths to move the media into a small regeneration chamber. The utility of this process is the smaller amount of gas produced, which can then be more easily destroyed catalytically.

A search using the search terms “carbon media heating electric” yields one similar patent, Carbon fiber composite molecular sieve electrically regenerable air filter media (Wilson et al.; U.S. Pat. No. 5,827,355, Oct. 27, 1998). This patent discusses the technique of electrical heating of carbon fibers, but we recognize that most other carbon media can be regenerated by passing an electric current through it. It also primarily address malodorous substances and focuses this technology on its employment in air, not biogas. Also, the media in this patent is a block of carbon fibers. Such a solid block is quite easily heated with an electric current.

Another relevant patent is Gas separation device based on electrical swing adsorption (Judkins et al.; U.S. Pat. No. 5,972,077, Oct. 26, 1999). However, this patent discusses the technique of electrical heating of carbon fibers, concerns itself with the remediation of hydrogen sulfide and carbon dioxide, not siloxanes, and focuses its employment for natural gas, not biogas.

### BRIEF DESCRIPTION OF THE DRAWINGS

FIG. 1 diagrammatically depicts a siloxane removal system flow diagram including regenerable media according to an embodiment of the invention.

FIG. 2 diagrammatically depicts an embodiment of the invented device.

FIG. 3 depicts an early prototype of the invented device, according to an embodiment of the invention.

FIG. 4 depicts an embodiment of a media-retaining insert, according to an embodiment of the invention.

FIG. 5 depicts an embodiment of a media regeneration vessel, according to an embodiment of the invention.

FIG. 6 depicts in more detailed view the media-retaining insert of FIG. 4, according to an embodiment of the invention.

FIG. 7 depicts in more detailed view the media regeneration vessel of FIG. 5, according to an embodiment of the invention.

### DETAILED DESCRIPTION OF THE PREFERRED EMBODIMENTS

Herein we propose yet another technique for heating the media. It requires no movement of the media to another location, yet heats the media evenly and the small volume of exhaust gas generated can be catalytically destroyed. Notably, the present invention recognizes that any carbon media can be regenerated by passing an electric current through it.

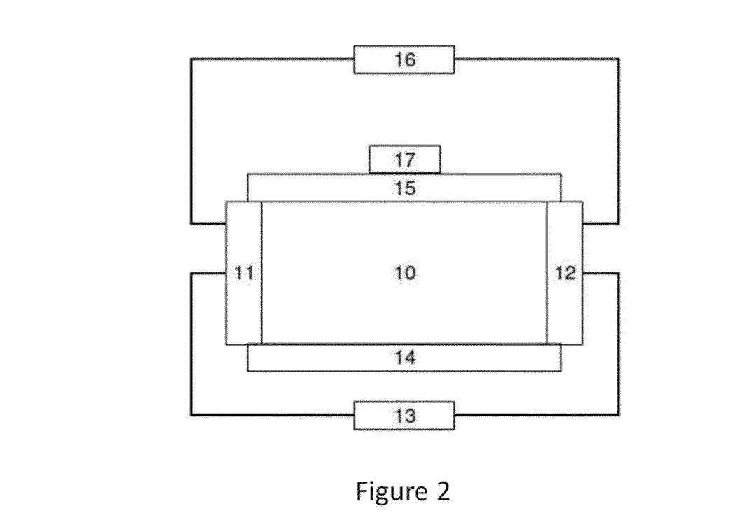

As is usual with adsorbent media, a pressure vessel is employed to contain the media. In this case, however, the vessel contains a special insert, typically configured as a rectangular cylinder, so that the media, in the insert, is held in a generally rectangular (e.g., square) shape, see FIG. 2. This is necessary because pressure vessels, by their nature, are economically fabricated as cylinders.

Two opposing faces of the insert are conductive, while the rest of the insert is manufactured from a suitable dielectric material. Such a dielectric material would be non-conductive, resistant to melting or deformation at the regeneration temperature within the range of 200-400° C., and have no components which could contaminate the gas for a specific application. Suitable dielectric materials could include a fluoropolymer material (e.g., TEFLON, etc.), a vitreous material (e.g., glass) or a ceramic material. The meaning of ‘suitable’ in this context means at least that a selected dielectric material is not so brittle that it would be easily damaged by vibration or handling that would be expected during ordinary use.

Unlike the solid block media of U.S. Pat. No. 5,827,355, a distinguishing feature of this invention is that we employ granular or pelletized media. Because granular or pelletized media is not as easily heated as is a solid block, we include another device as described below. The advantage to using granulated or pelletized media is that the large volume of media, sometimes on the order of tons, can be moved in and out of a vessel with a vacuum truck, which would be impossible with a solid block.

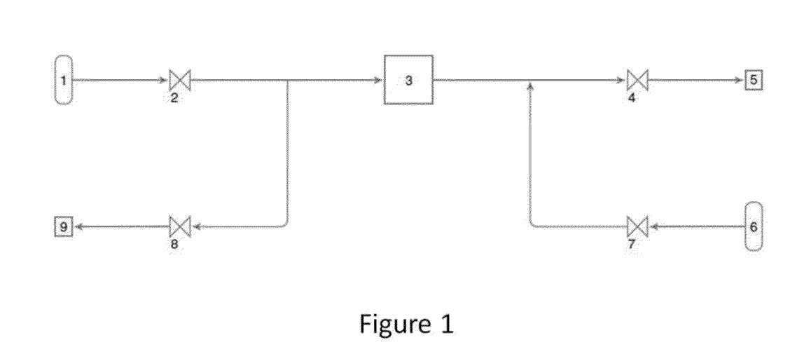

FIG. 1 depicts one contemplated application of the invention, the illustrated features of which include:
1: source of biogas;
2: biogas inlet valve;
3: regenerable media system, see FIG. 2;
4: biogas outlet valve;
5: biogas consumer such as a boiler, engine, turbine, or fuel cell;
6: purge gas, inert;
7: purge gas inlet valve;
8: contaminated gas outlet valve; and
9: flare or catalytic destruction system, used to eliminate collected contaminants.

FIG. 2 depicts an embodiment of the invented device, the illustrated features of which include:
10: carbon media, held within a box of dielectric and electrodes;
11,12: electrodes;
13: source for heating current, switchable;
14,15: dielectric elements;
16: capacitance device, which is a sensor for the control system; and
17: vibrator, which is driven by a control system (the control system is not depicted).

During normal operation, no heating current is passed through the media, and the media is used in a typical way, as depicted in FIG. 1, to clean gas. In other words, device 13 is turned off. When cleaning gas, valves 2 and 4 are open, while valves 7 and 8 are closed. Gas passes from the source of gas, 1, through the media, 3, toward the consumer, 5.

An important feature of this design is that media loading can be calculated from the relative capacitance change of the media. Such a capacitance-measuring device, 16, is also depicted in FIG. 2, and when the capacitance reaches a value which indicates that the media should be regenerated, the configuration of the system is changed, so that purge gas is back-flowed through the system. An inert gas, such as nitrogen, argon, carbon dioxide, or spent exhaust gas, flows from its source, 6, to a flare or catalytic destruction unit, 9. This is effected by closing valves 2 and 4 and opening valves 7 and 8, so that purge gas will flow backwards through the media, 3.

During this maneuver, heating current is passed through the media so that it begins to release the siloxanes or any other contaminant contained within it. This is effected by turning on the power source 13, until the capacitance measured by device 16 is low enough to indicate that the media has been regenerated.

During media regeneration as well, granular or pelletized media may crumble, oxidize, or in some other way lose electrical contact with the electrodes. This drives the net resistance of the system up and therefore the current downwards, which leads to a decrease in heating. This effect has been observed using the first prototype. To prevent this effect from happening, a vibrator 17 is attached to the exterior of the insert or to a vessel within which the insert is retained during use. This vibrator operates during system regeneration, and its operation is controlled by the control system.

Since the media is held in a square shape, the electric field through the media is homogeneous throughout. This ensures even heating and complete regeneration.

We recognize that non-carbon media which is conductive such as that invented by H. Shigemitsu (Polyamide resin composition excellent in plate adhesion, U.S. Pat. No. 4562221, Dec. 31, 1985) can also be used for this purpose.

We also recognize that the media can be used to clean any number of contaminants, such as volatile organic hydrocarbons.

We recognize that the media may not return to its original adsorptive capacity due to polymerization of the captured siloxanes. However, a control system can track the changes in capacitance and predict when the media may eventually require replacement.

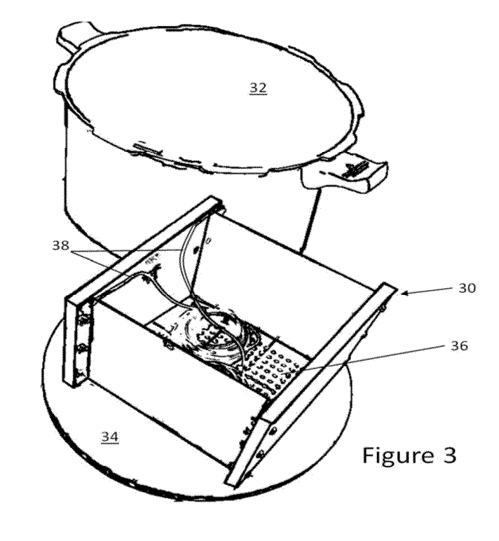

FIG. 3 depicts an early prototype of the invented device. White high-density polyethylene (HDPE) was employed for this low-temperature design. The insert 30 is placed in the pressure vessel 32, which in this case is a pressure cooker. A hole (not shown) in the bottom of the pressure cooker lets gas in; there is a seal (not shown) around the lower plate 34 to force the gas through the holes 36 in the bottom of the plate 34. The media (not shown) is placed into the insert. The gas comes off the top of the media and passes out of the pressure vessel through a hole in the lid. The electrical connections 38 pass through another hole in the lid (not shown) to a power source (not shown).

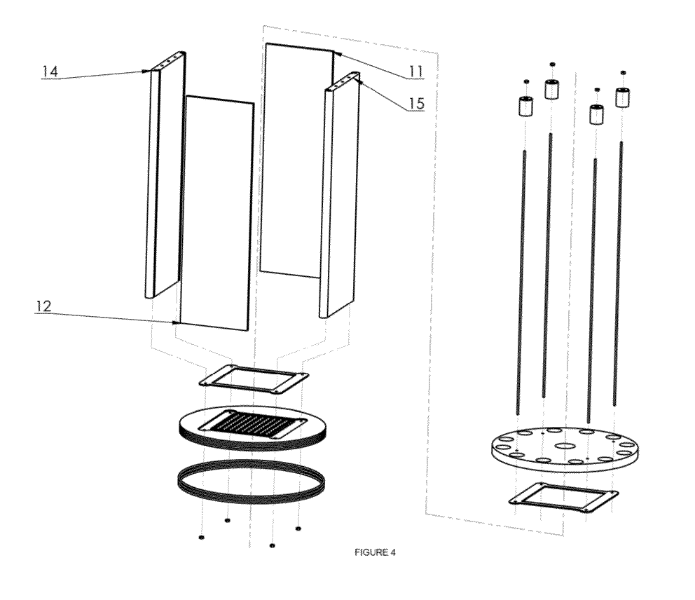

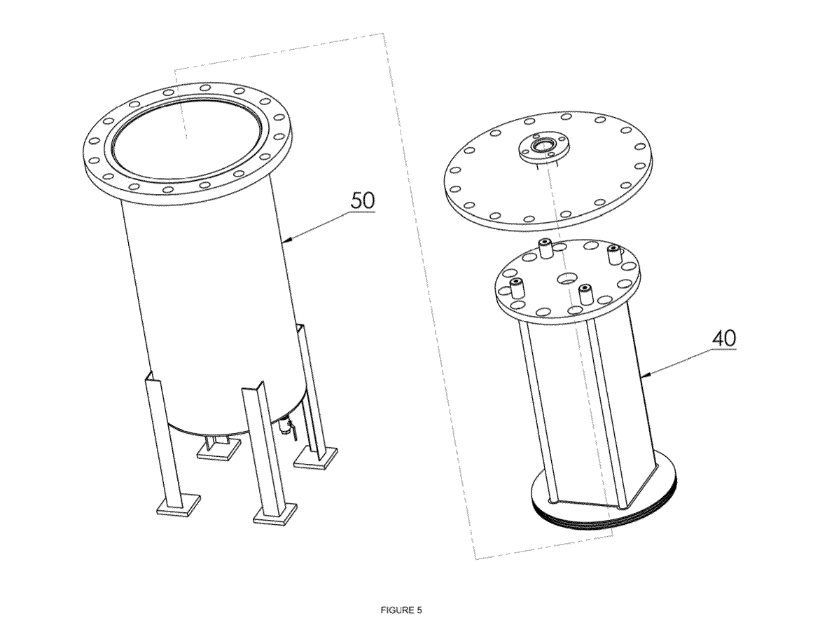

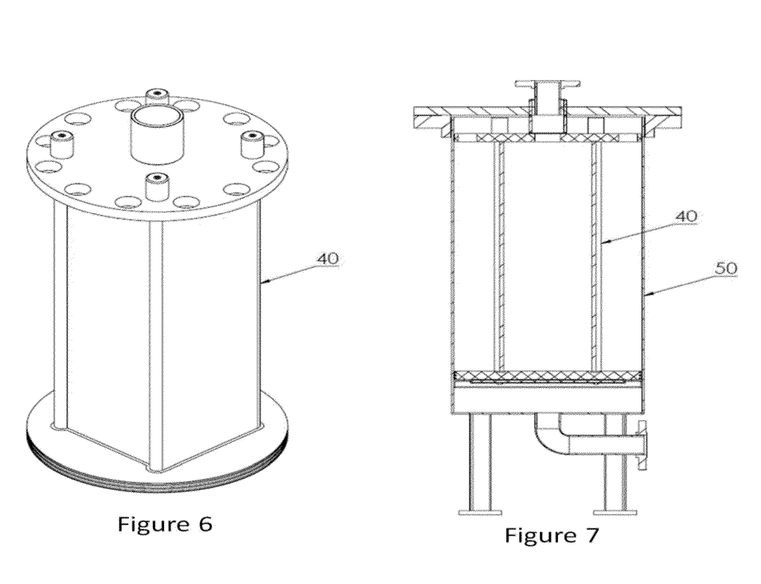

FIG. 4 depicts aspects and features of an embodiment of an insert 40 (shown in more detailed view in FIG. 6) for a second working prototype, to be used with (contained in) a regeneration vessel—such as that depicted at 50 in FIG. 5 (shown in more detailed view in FIG. 7)—of the invented system.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope of the invention.

It is further intended that any other embodiments of the present invention that result from any changes in application or method of use or operation, configuration, method of manufacture, shape, size, or material, which are not specified within the detailed written description or illustrations contained herein yet would be understood by one skilled in the art, are within the scope of the present invention.

Preferably, although not exclusively, those of skill in the art will appreciate that the invented method, system and apparatus described and illustrated herein may be implemented in a combination of the three, for purposes of low cost and flexibility.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

We claim:

1. An adsorbent-media regeneration device, comprising:
first and second dielectric elements configured to form opposing first and second sides of a rectangular cylinder;
first and second electrodes disposed adjacent the first and second dielectric elements and configured to form opposing third and fourth sides of the rectangular cylinder;
a capacitive device coupled with each of the first and second dielectric elements and configured to detect a capacitance of an adsorbent medium disposed within the rectangular cylinder; and
a switchable heat source coupled with each of the first and second dielectric elements.

2. The adsorbent-media regeneration device of claim 1, further comprising:
a first end plate disposed at and coupled with a first end of the rectangular cylinder and a second end plate disposed at and coupled with an opposing second end of the rectangular cylinder.

3. The adsorbent-media regeneration device of claim 2, wherein each of the first and second end plates include at least one aperture formed therethrough to permit a gas to enter and exit the rectangular cylinder and to flow directionally therethrough.

4. The adsorbent-media regeneration device of claim 3, further comprising:
a pressure vessel configured to receive and retain the rectangular cylinder therein, the pressure vessel including at least two apertures therein to permit inflow of a gas to the adsorbent medium and outflow of the gas from the adsorbent medium.

5. The adsorbent-media regeneration device of claim 3, wherein at least one of the opposing end plates includes an array of plural apertures.

6. The adsorbent-media regeneration device of claim 4, wherein a contiguous seal is disposed between an end plate of the rectangular cylinder and a corresponding inner surface of the pressure vessel, and wherein the seal surrounds each of one of the at least two apertures of the pressure vessel and one of the at least one apertures of the end plate, wherein the seal causes a gas flowing into the pressure vessel to enter the rectangular cylinder.

7. The adsorbent-media regeneration device of claim 2, further comprising:
a vibration-generating device coupled with one or more selected from the group consisting of the first electrode, the second electrode, the first dielectric element, the second dielectric element, the first end plate, the second end plate, and a vessel within which the rectangular cylinder is disposed during use.

8. The adsorbent-media regeneration device of claim 2, wherein the rectangular cylinder comprises one or more materials selected for their resistance to degradation when exposed to siloxane.

9. The adsorbent-media regeneration device of claim 1, wherein the dielectric material is one or more materials selected from the group consisting of a ceramic material, a vitreous material and a fluoropolymer material.

10. The adsorbent-media regeneration device of claim 1, wherein one or both of the capacitive device and the vibration-generating device is further operably coupled with a control system.

11. The adsorbent-media regeneration device of claim 2, wherein at least one of the first and second end plates is configured for alternative opening and resealing of the cylinder, enabling one or both of adding adsorbent media to or removing adsorbent media from the cylinder.

12. The adsorbent-media regeneration device of claim 2, wherein the rectanaular cylinder comprises one or more materials selected for their resistance to deformation when exposed to temperatures within the range of 200-400° C.

13. An adsorbent-media regeneration method, comprising:
passing an electrical current from a first electrode to a second electrode through an adsorbent medium, wherein the adsorbent medium is disposed intermediate the first and second electrodes;
detecting an electrical capacitance of the adsorbent medium indicative of loading thereof with an adsorbed material;
activating a source of heating current configured to administer a heating current to the adsorbent medium and the adsorbed material;
conveying an inert gas through the adsorbent medium;
monitoring a change in the electrical capacitance of the adsorbent medium to determine when the electrical capacitance reaches a value indicative of a reduced level of loading with an adsorbed material.

14. The adsorbent-media regeneration method of claim 13, further comprising:
administering an agitating force to the adsorbent medium, while administering the heating current to the adsorbent medium, by activating a vibration emitting device.

15. The adsorbent-media regeneration method of claim 13, further comprising:
controlling the administration of the agitating force by a control system operably coupled with the vibration emitting device.

16. The adsorbent-media regeneration method of claim 13, wherein the inert gas is one or more selected from the group consisting of nitrogen, argon, carbon dioxide, and spent exhaust gas.

17. The adsorbent-media regeneration method of claim 13, further comprising:
conveying the inert gas to either of a flare destruction unit or a catalytic destruction unit after conveying the inert gas through the adsorbent medium.

18. The adsorbent-media regeneration method of claim 13, wherein the inert gas is conveyed through the adsorbent medium in a direction opposite a direction of a gas flow through the adsorbent medium during normal use of the adsorbent medium to clean a process gas.
